(19) United States
(12) Patent Application Publication
(10) Pub. No.: US 2019/0141187 A1
(43) Pub. Date: May 9, 2019

(54) Dialing PBX Extensions From Cell Phone

(71) Applicant: XCAST LABS, INC., Northfield, IL (US)

(72) Inventor: Vladimir Smelyansky, Glenview, IL (US)

(73) Assignee: XCAST LABS, INC., Northfield, IL (US)

(21) Appl. No.: 16/184,371

(22) Filed: Nov. 8, 2018

Related U.S. Application Data
(60) Provisional application No. 62/583,263, filed on Nov. 8, 2017.

(51) Int. Cl. H04M 3/42

(52) U.S. Cl. CPC H04M 3/42331; H04W 88/02

(57) ABSTRACT

Embodiments of the present systems and methods may provide PBX functionality with mobile calling devices, such as cell phones. Embodiments may provide, for example, PBX functionality without the need to use land line (VoIP or PSTN, or any other) phones. For example, in an embodiment, a method of call completion may comprise receiving an indication of a called party phone to be dialed at a mobile device, determining, at the mobile device, whether the indication refers to an extension number of a private branch exchange or to a phone number in the public switched telephone network, and when the indication refers to an extension number of a private branch exchange dialing, at the mobile device, at least a phone number in the public switched telephone network in order to complete a call to the indicated called party phone.

### CROSS-REFERENCE TO RELATED APPLICATIONS

This application claims the benefit of U.S. Provisional Application No. 62/583,263, filed Nov. 8, 2017, the contents of which are incorporated herein in their entirety.

### BACKGROUND

The present invention relates to providing the capability to dial short numbers (PBX extensions) from a regular cell phone by utilizing the native phone dialer of the phone.

Today more and more people are eliminating their land lines and switching to mobile calling devices, such as cell phones, as their only phone. At the same time, people still rely on private branch exchanges (PBX) in business environments. Business users continue to rely on PBX systems for additional functionality, which is not available directly with cell phones.

Accordingly, a need arises for techniques that provide PBX functionality with mobile calling devices, such as cell phones.

### SUMMARY

Embodiments of the present systems and methods may provide PBX functionality with mobile calling devices, such as cell phones. Embodiments may provide, for example, PBX functionality without the need to use land line (VoIP or PSTN, or any other) phones.

For example, in an embodiment, a method of call completion may comprise receiving an indication of a called party phone to be dialed at a mobile device, determining, at the mobile device, whether the indication refers to an extension number of a private branch exchange or to a phone number in the public switched telephone network, and when the indication refers to an extension number of a private branch exchange dialing, at the mobile device, at least a phone number in the public switched telephone network in order to complete a call to the indicated called party phone.

In embodiments, the dialed phone number in the public switched telephone network may be a direct inward dialing number. The direct inward dialing number may be obtained from configuration infbrmation of the private branch exchange downloaded from the private branch exchange and stored on the mobile device. The dialed phone number in the public switched telephone network may comprise a public switched telephone network number of a private branch exchange and an extension number of the private branch exchange dialed thereafter. The public switched telephone network number of the private branch exchange and the extension number of the private branch exchange may be obtained from configuration information of the private branch exchange downloaded from the private branch exchange and stored on the mobile device. Whether the indication refers to an extension number of a private branch exchange or to a phone number in the public switched telephone network may be determined based on a number of digits in the indication.

In an embodiment, a system for call completion may comprise a processor, memory accessible by the processor, and computer program instructions stored in the memory and executable by the processor to perform: receiving an indication of a called party phone to be dialed at a mobile device, determining, at the mobile device, whether the indication refers to an extension number of a private branch exchange or to a phone number in the public switched telephone network, and when the indication refers to an extension number of a private branch exchange dialing, at the mobile device, at least a phone number in the public switched telephone network in order to complete a call to the indicated called party phone.

In an embodiment, a computer program product for call completion may comprise a non-transitory computer readable storage having program instructions embodied therewith, the program instructions executable by a computer, to cause the computer to perform a method comprising: receiving an indication of a called party phone to be dialed at a mobile device, determining, at the mobile device, whether the indication refers to an extension number of a private branch exchange or to a phone number in the public switched telephone network, and when the indication refers to an extension number of a private branch exchange dialing, at the mobile device, at least a phone number in the public switched telephone network in order to complete a call to the indicated called party phone.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 illustrates an exemplary block diagram of a system in which the present systems and methods may be implemented.

FIG. 2 illustrates an exemplary flow diagram of a process according to embodiments of the present techniques.

FIG. 3 illustrates an exemplary user interface according to embodiments of the present techniques.

FIG. 4 illustrates an exemplary user interface according to embodiments of the present techniques.

FIG. 5 illustrates an exemplary display according to embodiments of the present techniques.

FIG. 6 illustrates an exemplary block diagram of a computing device according to embodiments of the present techniques.

### DETAILED DESCRIPTION

Embodiments of the present systems and methods may provide PBX functionality with mobile calling devices, such as cell phones. Embodiments may provide, for example, PBX functionality without the need to use land line (VoIP or PSTN, or any other) phones.

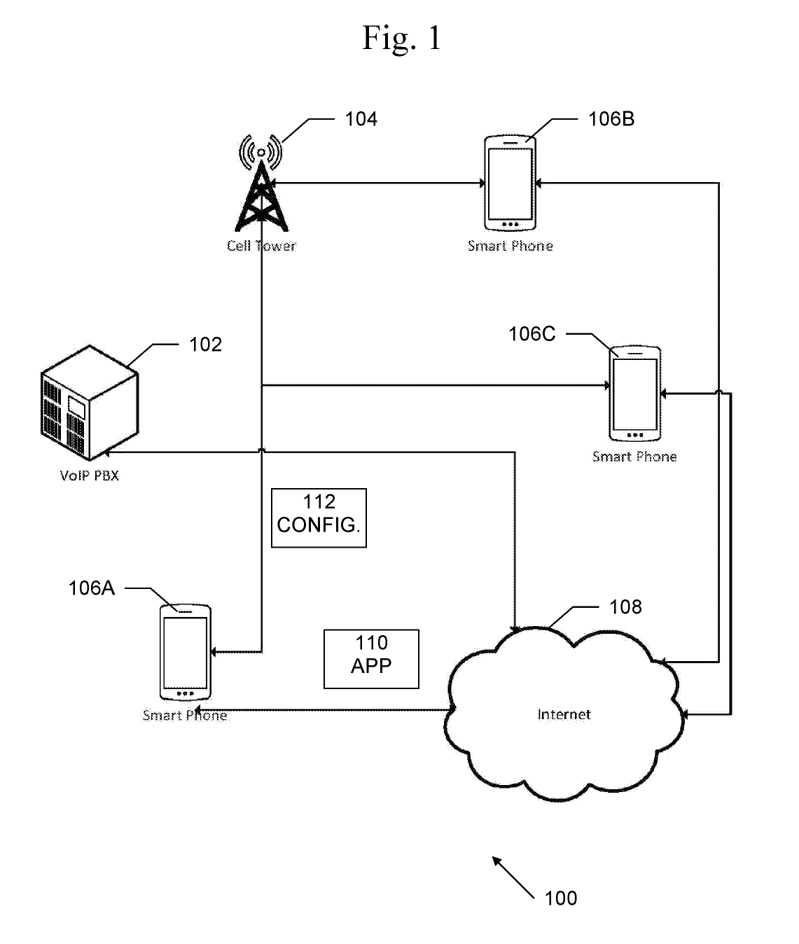

An example of a system 100 in which the present techniques may be implemented is shown in FIG. 1. In this example, system 100 may include a PBX 102, a mobile carrier network 104, a plurality of mobile phones, such as smartphones 106A-C, and the Internet 108. PBX 102 may be a multi-line, automated telephone exchange system, which switches incoming and outgoing call to the appropriate destinations. Mobile carrier network 104 may be one or more mobile communications networks operated by one or more carriers offering mobile service to customers, such as the users of smartphones 106A-C. PBX 102 may have voice connectivity with mobile carrier network 104, for example over the PSTN and/or one or more trunk lines, and with smartphones 106A-C via mobile carrier network 104. Likewise, PBX 102 may have data connectivity with mobile carrier network 104 directly or via Internet 108, and with smartphones 106A-C via mobile carrier network 104 and Internet 108.

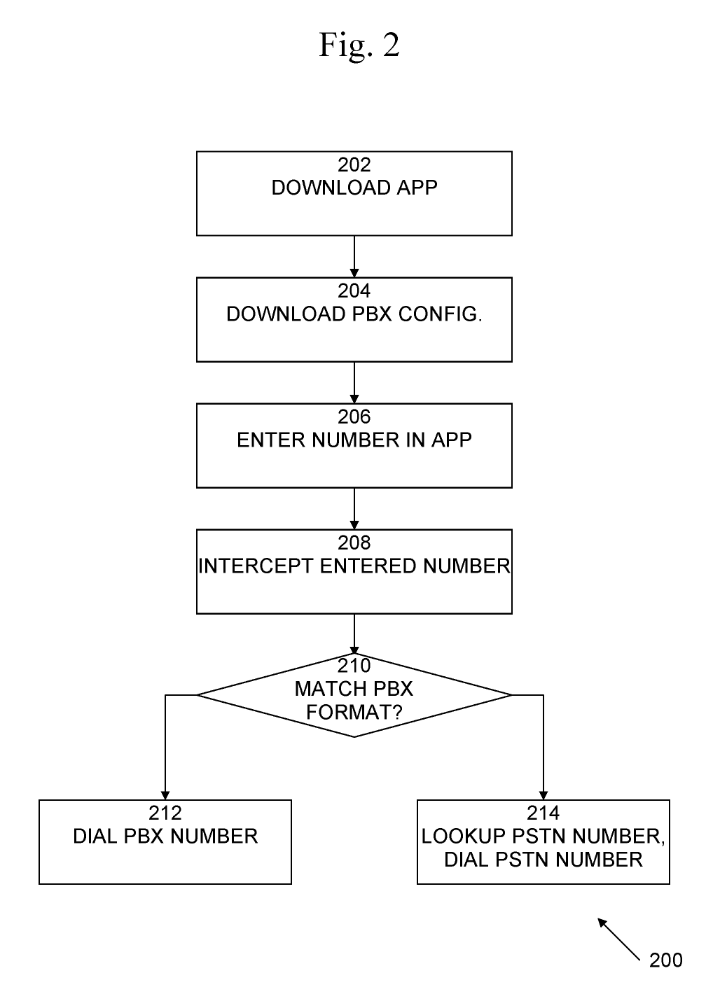

An exemplary flow diagram of a process 200 according to embodiments of the present techniques is shown in FIG. 2. It is best viewed in conjunction with FIG. 1. Process 200 begins with 202, in which an app 110 may be downloaded via Internet 108 and/or mobile carrier network 104 to a smartphone 106A-C. App 110 may implement or participate in the remainder of process 200. App 110 may, for example, be downloaded from the APP STORE® for APPLE® phones, GOOGLE PLAY® for ANDROID® phones, etc.

At 202, configuration information 112 for a PBX 102 may be entered into app 110. In embodiments, PBX 102 may be configured so as to associate extension numbers with Direct Inward Dial (DID) numbers. DID numbers are standard telephone numbers that provide the capability to directly dial extensions on a PBX. In embodiments, PBX 102 may not be configured to use DID numbers, but rather may be configured with a PSTN number for the PBX itself and may be further configured to, upon answering a call to the PBX number, accept entry of an extension number to which the call is to be directed. Configuration information 112 may be downloaded directly from PBX 102, downloaded from a configuration server located on Internet 108, or may be entered manually. Configuration information 112 may include a length of the PBX extension numbers (3 digits, 4 digits, etc.) and a PBX directory that may include a list of PBX users, including the PCX extension numbers and the associated DID numbers and/or PBX number.

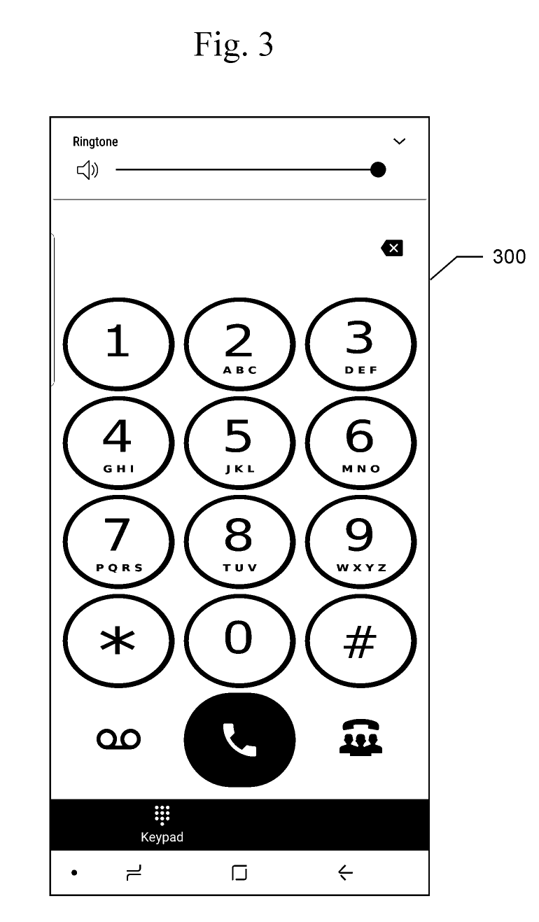

At 206, a user of a smartphone 106A-C may use the native phone dialer of the smartphone or an app 110 to enter a number of a party to be called, using, for example, a user interface, such as user interface 300, shown in FIG. 3. At 208, app 110 may intercept the entered number from the native phone dialer and at 210 may determine whether the entered number matches a PBX extension number format. For example, a PBX extension number may have 3 or 4 digits, while a regular PSTN number may have 7 or 10 digits. If, at 210, it is determined that the entered number does not match a PBX extension number format, then the process continues with 214, in which app 110 passes the entered number without modification to the phone dialer functionality of the phone, which may then dial the number. However, if, at 210, it is determined that the entered number does match a PBX extension number format, such as 3 or 4 digits, then the process continues with 212, in which app 110 uses the entered number to look up a corresponding entry in configuration information 112 and passes the corresponding PSTN number to the phone dialer functionality of the phone, which may then dial the number. In embodiments, configuration information 112 may include a DID number, in which case the phone dialer functionality may dial the DID number to complete the call. In embodiments, configuration information 112 may include a PBX number, in which case the phone dialer functionality may dial the PBX number, followed, possibly after a delay, by the extension number, in order to complete the call.

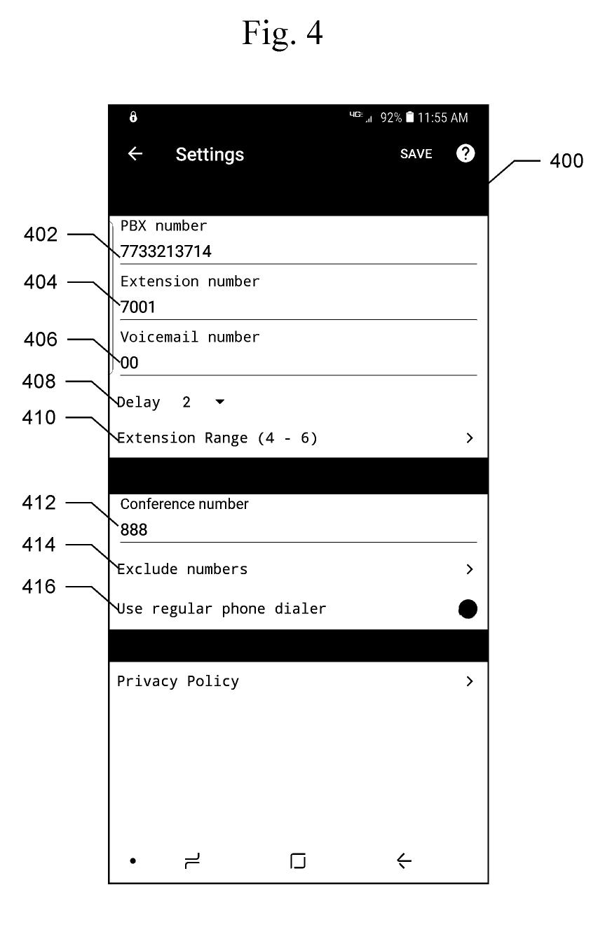

An example of an entry user interface 400 for configuration information 112 in app 110 is shown in FIG. 4. As shown in this example, entry user interface 400 may include a PBX number 402, an extension number 404, a voicemail number 406, a delay 408 to wait before an extension number is dialed, an extension number format 410, a conference number 412, numbers to exclude from the process 414, and a setting as to whether to use the regular phone dialer screen or whether to use the app phone dialer screen 300.

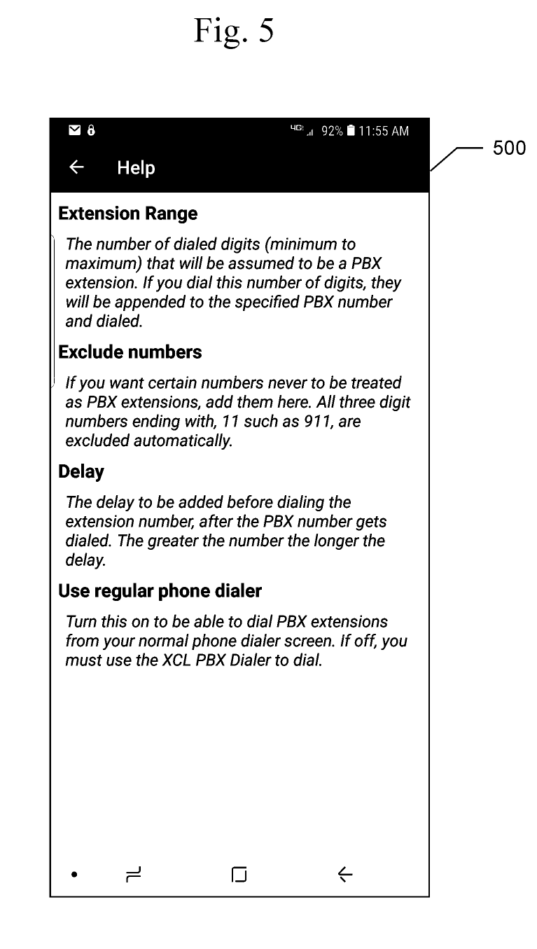

An example of a display 500 for help information in app 110 is shown in FIG. 5. In this example, the help information describes the operation of features such as the Extension Range or format—the number of dialed digits (minimum to maximum) that will be considered to be a PBX extension. In embodiments, if this number of digits is entered, they may be appended to the specified PBX number and dialed. Exclude numbers—indicating certain numbers that are not to be treated as PBX extensions. For example, three digit numbers ending with, 11 such as 911, may also be excluded automatically. Delay—the delay to be added before dialing the extension number, after the PBX number gets dialed. The greater the number the longer the delay. Use regular phone dialer—turn this on to dial PBX extensions from the regular phone dialer screen. If off, the app phone dialer screen 300 is used.

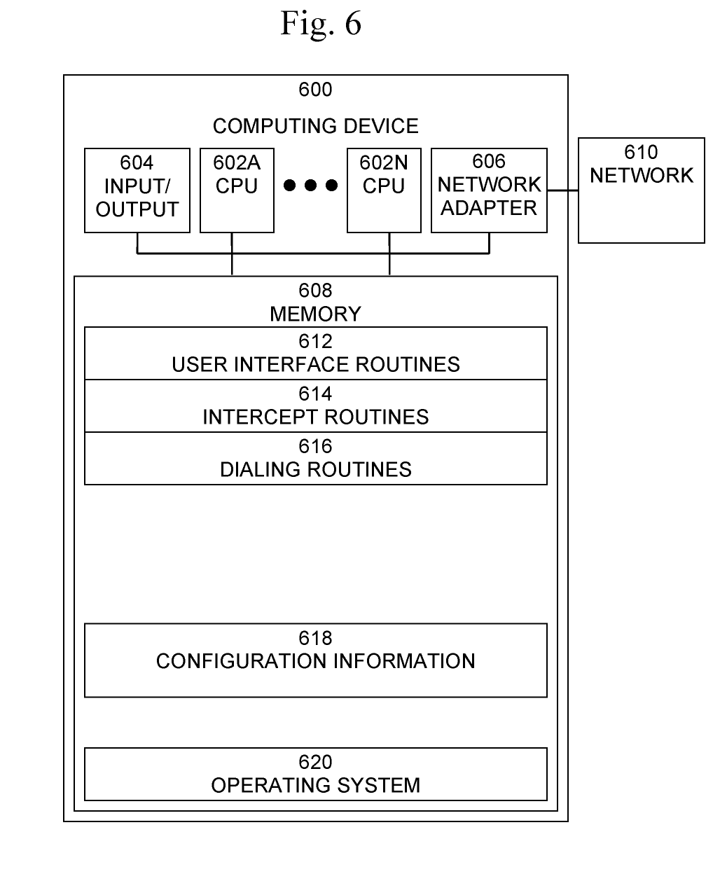

An exemplary block diagram of a computing device 600, in which processes involved in the embodiments described herein may be implemented, is shown in FIG. 6. Computing device 600 typically is implemented as a processor in a mobile phone device, such as a smartphone. Computing device 600 may include one or more processors (CPUs) 602A-602N, input/output circuitry 604, network adapter 606, and memory 608. CPUs 602A-602N execute program instructions in order to carry out the functions of the present communications systems and methods. Typically, CPUs 602A-602N are one or more microprocessors, such as an ARM® processor. FIG. 6 illustrates an embodiment in which computing device 600 is implemented as a single multi-processor computer system, in which multiple processors 602A-602N share system resources, such as memory 608, input/output circuitry 604, and network adapter 606. However, the present communications systems and methods also include embodiments in which computing device 600 is implemented as a plurality of networked computer systems, which may be single-processor computer systems, multi-processor computer systems, or a mix thereof.

Input/output circuitry 604 provides the capability to input data to, or output data from, computing device 600. For example, input/output circuitry may include input devices, such as keyboards, mice, touchscreens, touchpads, trackballs, scanners, analog to digital converters, etc., output devices, such as video adapters, monitors, display screens, printers, etc., and input/output devices, such as, modems, etc. Network adapter 606 interfaces device 600 with a network 610. Network 610 may be any public or proprietary LAN or WAN, including, but not limited to the Internet.

Memory 608 stores program instructions that are executed by, and data that are used and processed by, CPU 602 to perform the functions of computing device 600. Memory 608 may include, for example, electronic memory devices, etc.

The contents of memory 608 may vary depending upon the function that computing device 600 is programmed to perform. In the example shown in FIG. 6, exemplary memory contents are shown representing routines and data for embodiments of the processes described above. However, one of skill in the art would recognize that these routines, along with the memory contents related to those routines, may not be included on one system or device, but rather may be distributed among a plurality of systems or devices, based on well-known engineering considerations. The present systems and methods may include any and all such arrangements.

In the example shown in FIG. 6, memory 608 may include user interface routines 612, intercept routines 614, dialing routines 616, configuration information 616, and operating system 618. User interface routines 612 may include software routines to display screens and controls to a user, such as screen 300, 400, 500, shown in FIGS. 3, 4, and 5, respectively. Intercept routines 614 may include software routines to intercept entered numbers and determine whether those entered numbers are PBX extension numbers. Dialing routines 614 may include software routines to dial PSTN and PBX extensions using configuration information 618. Operating system 620 may provide overall system functionality. Examples of operating systems that are typically used in mobile devices include APPLE IOS® and GOOGLE ANDROID®.

As shown in FIG. 6, the present communications systems and methods may include implementation on a system or systems that provide multi-processor, multi-tasking, multi-process, and/or multi-thread computing, as well as implementation on systems that provide only single processor, single thread computing.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method of call completion comprising:
receiving an indication of a called party phone to be dialed at a mobile device;
determining, at the mobile device, whether the indication refers to an extension number of a private branch exchange or to a phone number in the public switched telephone network; and
when the indication refers to an extension number of a private branch exchange dialing, at the mobile device, at least a phone number in the public switched telephone network in order to complete a call to the indicated called party phone.

2. The method of claim 1, wherein the dialed phone number in the public switched telephone network is a direct inward dialing number.

3. The method of claim 2, wherein the direct inward dialing number is obtained from configuration information of the private branch exchange downloaded from the private branch exchange and stored on the mobile device.

4. The method of claim 1, wherein the dialed phone number in the public switched telephone network comprises a public switched telephone network number of a private branch exchange and an extension number of the private branch exchange dialed thereafter.

5. The method of claim 4, wherein the public switched telephone network number of the private branch exchange and the extension number of the private branch exchange are obtained from configuration information of the private branch exchange downloaded from the private branch exchange and stored on the mobile device.

6. The method of claim 1, wherein whether the indication refers to an extension number of a private branch exchange or to a phone number in the public switched telephone network is determined based on a number of digits in the indication.

7. The method of claim 1, wherein a number of the called party phone to be dialed is entered into a native phone dialer of the mobile device and the indication of a called party phone is generated by intercepting the entered number.

8. A system for call completion, the system comprising a processor, memory accessible by the processor, and computer program instructions stored in the memory and executable by the processor to perform:
receiving an indication of a called party phone to be dialed at a mobile device;
determining, at the mobile device, whether the indication refers to an extension number of a private branch exchange or to a phone number in the public switched telephone network; and
when the indication refers to an extension number of a private branch exchange dialing, at the mobile device, at least a phone number in the public switched telephone network in order to complete a call to the indicated called party phone.

9. The system of claim 8, wherein the dialed phone number in the public switched telephone network is a direct inward dialing number.

10. The system of claim 9, wherein the direct inward dialing number is obtained from configuration information of the private branch exchange downloaded from the private branch exchange and stored on the mobile device.

11. The system of claim 8, wherein the dialed phone number in the public switched telephone network comprises a public switched telephone network number of a private branch exchange and an extension number of the private branch exchange dialed thereafter.

12. The system of claim 11, wherein the public switched telephone network number of the private branch exchange and the extension number of the private branch exchange are obtained from configuration information of the private branch exchange downloaded from the private branch exchange and stored on the mobile device.

13. The system of claim 8, wherein whether the indication refers to an extension number of a private branch exchange or to a phone number in the public switched telephone network is determined based on a number of digits in the indication.

14. The method of claim 8, wherein a number of the called party phone to be dialed is entered into a native phone dialer of the mobile device and the indication of a called party phone is generated by intercepting the entered number.

15. A computer program product for determining treatment effects, the computer program product comprising a non-transitory computer readable storage having program instructions embodied therewith, the program instructions executable by a computer, to cause the computer to perform a method comprising:
receiving an indication of a called party phone to be dialed at a mobile device;
determining, at the mobile device, whether the indication refers to an extension number of a private branch exchange or to a phone number in the public switched telephone network; and
when the indication refers to an extension number of a private branch exchange dialing, at the mobile device, at least a phone number in the public switched telephone network in order to complete a call to the indicated called party phone.

16. The system of claim 15, wherein the dialed phone number in the public switched telephone network is a direct inward dialing number.

17. The system of claim 16, wherein the direct inward dialing number is obtained from configuration information of the private branch exchange downloaded from the private branch exchange and stored on the mobile device.

18. The system of claim 15, wherein the dialed phone number in the public switched telephone network comprises a public switched telephone network number of a private branch exchange and an extension number of the private branch exchange dialed thereafter.

19. The system of claim 18, wherein the public switched telephone network number of the private branch exchange and the extension number of the private branch exchange are obtained from configuration information of the private branch exchange downloaded from the private branch exchange and stored on the mobile device.

20. The system of claim 15, wherein whether the indication refers to an extension number of a private branch exchange or to a phone number in the public switched telephone network is determined based on a number of digits in the indication.

21. The method of claim 15, wherein a number of the called party phone to be dialed is entered into a native phone dialer of the mobile device and the indication of a called party phone is generated by intercepting the entered number.
